(19) United States
(12) Patent Application Publication
(10) Pub. No.: US 2006/0001256 A1
(43) Pub. Date: Jan. 5, 2006

(54) Decorative three dimensional cover for a book

(76) Inventor: Piers Morgan, LW Amsterdam (NL)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 10/883,461

(22) Filed: Jul. 2, 2004

(51) Int. Cl. B42D 3/00

(52) U.S. Cl. 281/34

(57) ABSTRACT

A removable cover for a book has a first member with a body. The body has a first panel and the first panel forms a first pocket with the body. The removable cover has a second member hinge connected to the body to pivot between a first position and a second position. The first position is defined as a closed position in which the second member is on the first member. The second position is defined as an opened position in which the first member is pivoted and elevated relative to the second member. The second member has a second panel with the second panel forming a second pocket with the second member. The book is in the first pocket and is in the second pocket and the cover is positioned on the book.

### BACKGROUND OF THE INVENTION

1. Field of the Invention

The present invention relates to a cover for a book. More particularly, the present invention relates to a book cover that is a decorative item, which item can be a three dimensional toy.

2. Description of the Related Art

Book covers are known in the art. One such book cover is a cloth book cover disclosed in U.S. Pat. No. 6,257,622 B1 to Peker. The Peker book cover is a spandex elastic cloth with a spine area, front and back cover portions. Each of the front and the back cover portions has a first pocket and a second pocket. The spine area has a third pocket on an exterior side of the book cover. The third pocket is fashioned to retain pens, pencils, rulers, and the like. The cloth book cover is generally orthogonal and rectangular, and thus, shaped substantially the same as a book.

The book covers of the prior art have limited usefulness. The covers although providing benefits to protect the book from fire and water penetration generally lack any other functionality.

Also, a consumer may purchase impulsively, since it will be attractive thereto, a book with a cover that has a geometry that is a three-dimensional toy or play article. Moreover, children typically would like a book cover that simultaneously looks like a toy and is used as a toy. In this manner, a child may play with the cover having the book therein and then at a later time, read the book.

Accordingly, there is a need for a book cover that may be a toy or play article.

### SUMMARY OF THE INVENTION

It is object of the present invention to provide a book cover that is also a toy or play item.

It is another object of the present invention to provide a book cover that a pair of members each with a structure for easy application to and removal from a book.

It is yet another object of the present invention to provide a book cover that has a pair of deformable or sponge-type members.

It is still another object of the present invention to provide such a book cover with the first deformable member adapted to pivot relative to the second deformable member to reveal a book therein.

It is a further object of the present invention to provide such a book cover with the first deformable member being adapted to pivot relative to the second deformable member to reveal a book therebetween with an aesthetically pleasing design or pattern on an exterior side thereof.

These and other objects and advantages are achieved by a removable cover for a book according to the present invention. The removable cover has a first member with a body. The body has a first panel. The first panel forms a first pocket with the body. The removable cover also has a second member being hinge connected to the body to pivot between a first position and a second position. The first position is a closed position in which the second member is on the first member. The second position is an opened position in which the first member is pivoted and elevated relative to the second member. The second member has a second panel and the second panel forms a second pocket with the second member. A first binding portion of book is in the first pocket and a second binding portion of the book is positionable in the second pocket, so that the first and second binding portions of the book are in the removable cover.

### DESCRIPTION OF THE DRAWINGS

FIG. 1 is a side perspective view of a book cover of the present invention in a closed position.

FIG. 2 is a top view of the book cover of FIG. 1 in the closed position.

FIG. 3 is a rear view of the book cover of FIG. 1 in a partially opened position.

FIG. 4 is a bottom view of the book cover of FIG. 1.

FIG. 5 is a cross-sectional view of the book cover along line 4-4 of FIG. 4.

FIG. 6 is another side view of the book cover of FIG. 1 in an opened position.

FIG. 7 is a top view of the book cover of FIG. 2 in a fully opened position.

### DETAILED DESCRIPTION OF THE INVENTION

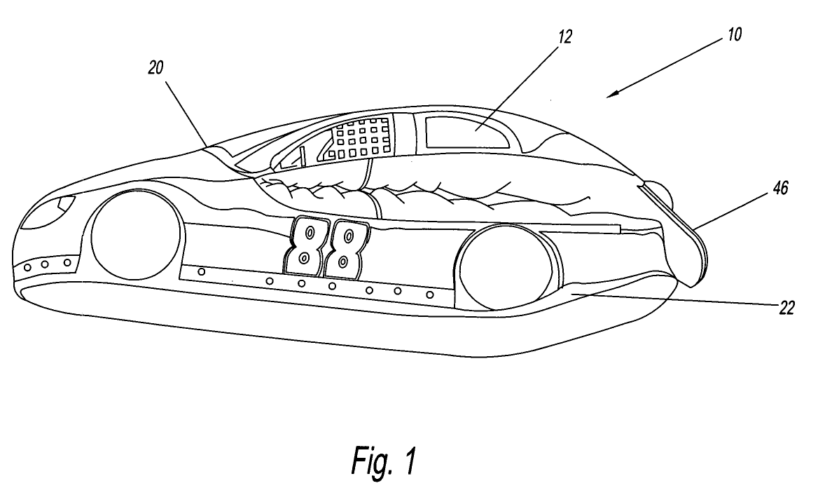

Referring to the drawings and in particular FIG. 1, there is shown a book cover of the present invention generally represented by reference numeral 10. The book cover 10 has a three dimensional shape. The shape of the book cover 10 may be any geometry or pattern 12 that provides a three-dimensional toy or play item. The book cover 10 preferably has the pattern 12 substantially indicative of the information topic of the book. In this preferred embodiment, the book cover 10 has the pattern 12 that is the same as the topic of the book disposed therein. Preferably, the book cover 10 is soft and resilient. Accordingly, the book cover 10 is a pattern 12 or an object that a child may manipulate or play with as a toy.

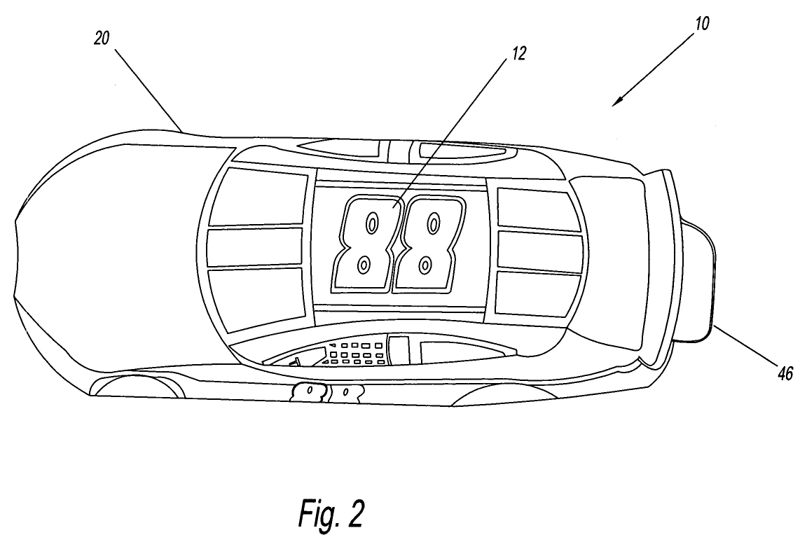

Referring to the embodiment of FIGS. 1 and 2, the pattern 12 is a toy automobile. One skilled in the art will appreciate, as noted above, that the pattern 12 may be a racecar, an automobile, an animal, a motorcycle, a transportation device, a character, or any other commercially acceptable pattern known in the art. In this embodiment of the present invention, the pattern 12 has a racecar number, racecar lettering, and images of a windshield, a rear window, side windows, tires, and doors.

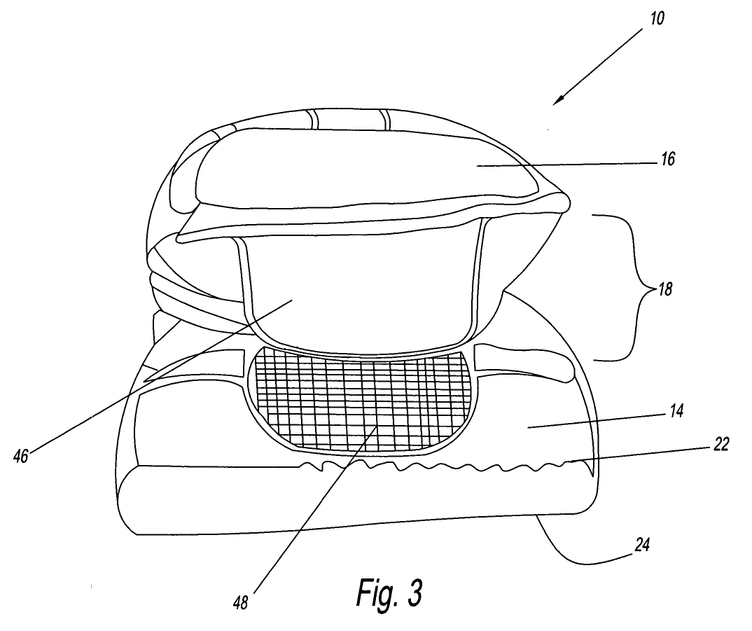

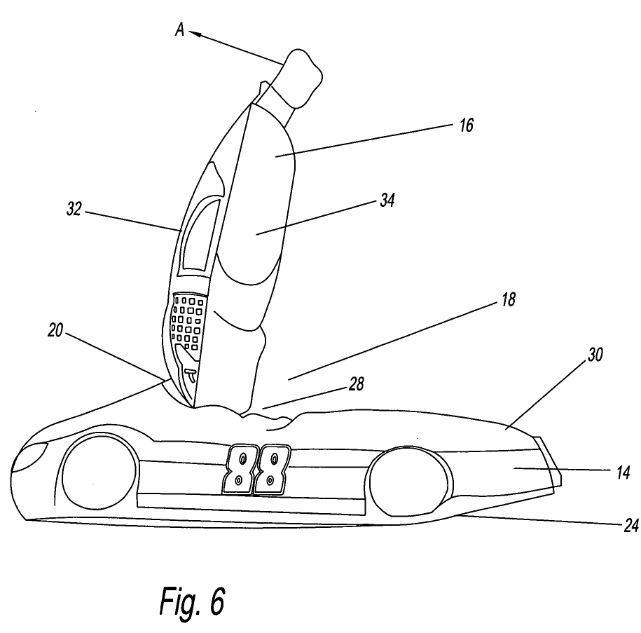

Referring to FIG. 3, which shows a rear view of the book cover 10, the book cover preferably has a first or base member 14 and a second or upper member 16. Preferably, the first member 14 is connected to the second member 16 to define a space 18 therebetween. Preferably, the first member 14 is connected to the second member 16 by a pivot 20 shown clearly in FIG. 6. In this embodiment, the pivot 20 is a line of stitching that connects the first member 14 to the second member 16. One skilled in the art should appreciate that the pivot 20 may be any other type pivot known in the art for accomplishing the same opening and closing action that complies with the opening and closing of a book.

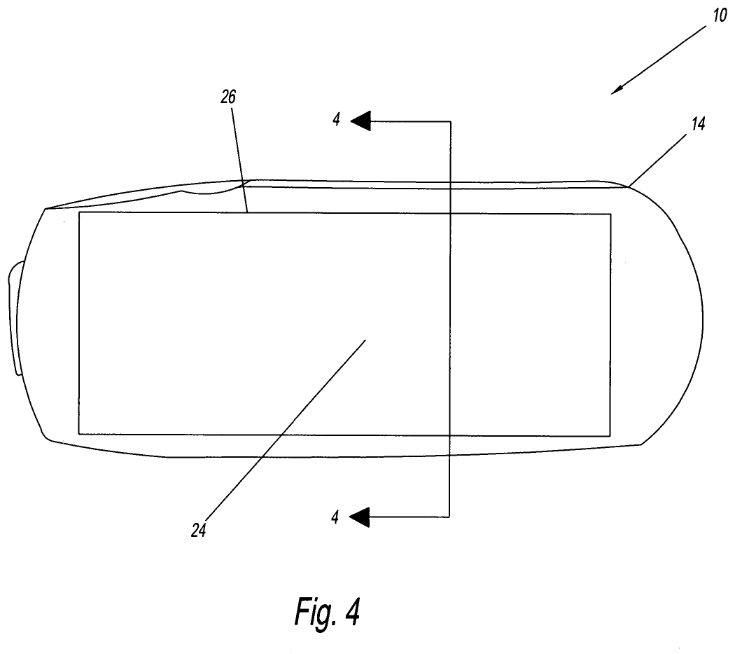

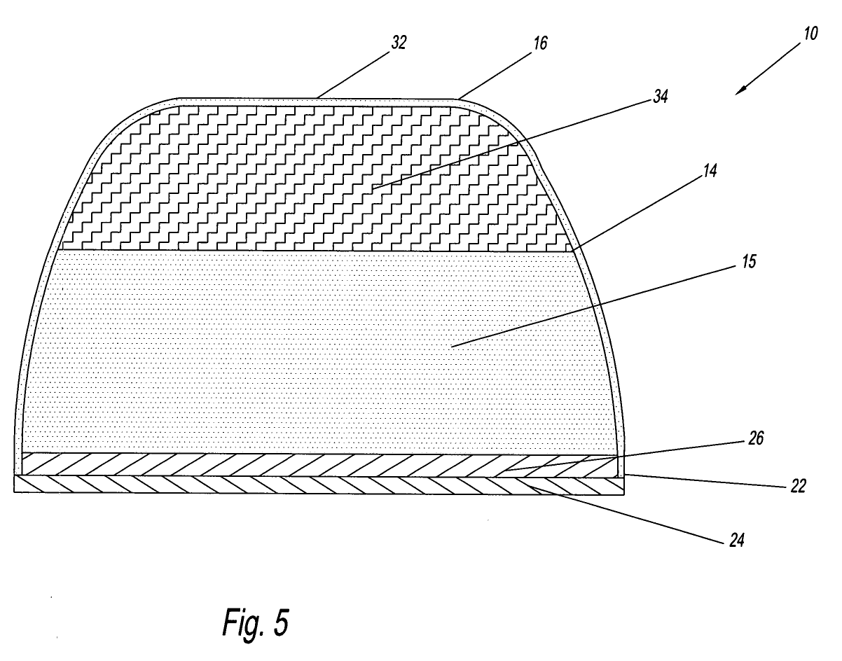

Referring to FIGS. 3 and 4, the first member 14 preferably has a base 22. The first member 14 has a bottom portion 24 or surface that contacts a substance, such as a table or the ground. The bottom surface 24 preferably is relatively flat. The book cover 10 has a resilient member 26. The resilient member 26 show in FIG. 5 may be connected to the base 22 or alternatively, formed in the base 22. The resilient member 26 provides resiliency and support to the book cover 10. The resilient member 26 may made of foam, wood, a paperboard, a cardboard member, a thermoplastic, a metal or aluminum sheet, a thermoset, a polymer, or any other lightweight or somewhat flexible member known in the art. Most preferably, the resilient member 26 is a die cut plastic sheeting.

The first member 14 preferably has an interior 15. The interior 15 of the first member 14 is preferably filled with a material, preferably a soft material. The soft material may be any material known in the art including, but not limited to, foam, cloth, cloth stuffing, packing, paper, cotton or any combinations thereof. The soft material therein preferably cushions the book cover 10 to make the book cover suitable for manipulation by a small child. The second member 16, similar to the first member 14, preferably has a second interior 34. The second interior 34 of the second member 16 is preferably also filled with the soft material. The soft material in the second interior space 34 may be the same as the soft material in the interior space 15 or a different soft material. The second interior space 34 also preferably cushions the book cover 10 to allow the child to manipulate the book cover a toy.

Referring to FIG. 6, the first member 14 preferably has a narrow indentation 28. The indentation 28 is formed in a first top side 30 of the first member 14 that is in contact with the second member 16 in a closed position. The indentation 28 preferably has a height that is complementary to a thickness of the book. The indentation 28 allows the book to rest in the indentation and the second member 16 to rest on the first member 14 with the book therebetween in an aesthetically pleasing manner.

The second member 16 preferably forms a second top side 32 of the book cover 10. The second top side 32 preferably has a curvature to form the pattern 12, however one skilled in the art should appreciate that the book cover 10 may be formed as any suitable pleasing shape known in the art to grasp the book cover 10.

The second member 16 preferably pivots about the pivot 20 from the first position to the second position by application of a pulling or tensile force on the second member 16 by the user. The second member 16 preferably pivots about the pivot 20 to expose the space 18 therebetween in a direction of reference arrow A.

The space 18 therebetween is adjacent to the indentation 28 in the first member 14. Preferably, the indentation 28 of the first member 14 is preferably any sharp recess in the first member to allow the book to rest therein. The indentation 28 preferably is generally orthogonal shaped and has a complementary size to receive a book therein. One skilled in the art should appreciate that the indentation 28 may in other embodiment have a size that is larger or smaller to compensate for differently sized books such as a paperback book, a hardcover book or a magazine.

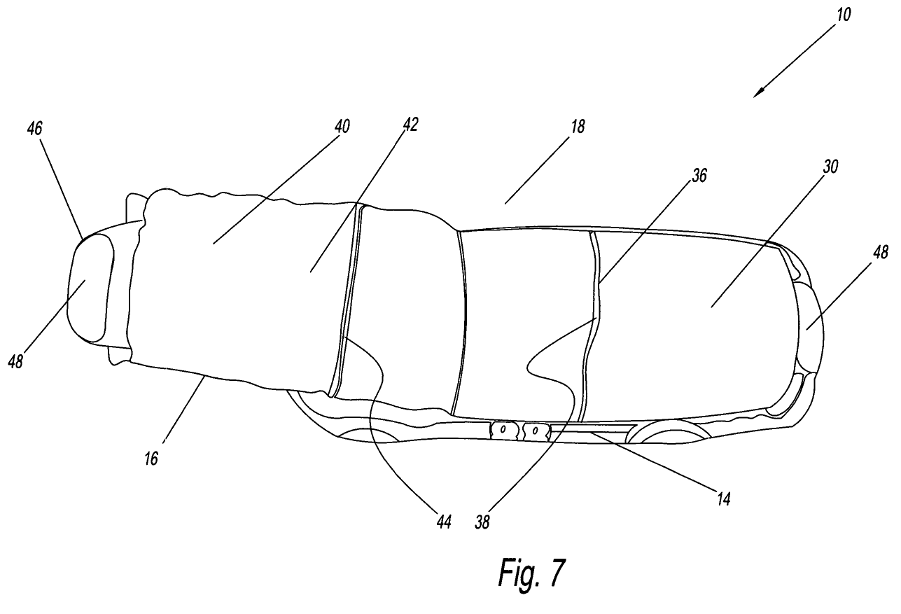

Referring to FIG. 7, the first member 14 preferably has a first book jacket portion 36 therein. The first book jacket portion 36 is preferably stitched on three sides thereof to provide one side that is open for receipt of a book jacket or cover. The first book jacket portion 36 is preferably made from a cloth material and is connected to the first top side 30 of the first member 14 by a stitching operation. However, one skilled in the art should appreciate that the first book jacket portion 36 may be formed from a molding operation, or formed by a connection operation such as by adhering with an adhesive or alternatively by being integral with the first member 14. Preferably, the first book jacket portion 36 may be any member known in the art that is connected to the first top side 30 of the first member 14 for forming a first pocket 38 therein. Preferably, the first pocket 38 selectively retains a first jacket or cover of a book.

The second member has a second bottom side 40 with a second book jacket portion 42. The second book jacket portion 42 preferably is also a relatively thin piece of fabric that is stitched to the second bottom side 40 of the second member 14. The second book jacket portion 42 is also preferably stitched on three sides thereof to provide one side that is open for receipt of a book jacket or cover. The second book jacket portion 42 may be any member known in the art for forming a second pocket 44. Preferably, the second pocket 44 selectively retains a second jacket or the cover of the book. Most preferably, the first book jacket portion 36 and the second book jacket portion 42 cooperate with one another and are disposed in a complementary location relative to one another. Preferably, the first book jacket portion 36 and the second book jacket portion 42 are disposed substantially adjacent to one another when the book cover 10 is in the opened position. In this manner, a book provider may open a book and place each jacket of the book in the respective first book jacket portion 36 and the second book jacket portion 42. Thereafter, the book provider may close the first member 14 relative to the second member 16 with the book in the space 18 and place the book cover 10 on a counter for sale in a removable manner.

The book cover 10 further has a flap 46. Preferably, the flap 46 is a resilient member that is connected to the second member 16 at an end thereof. The flap 46 has a gripping portion. The flap 46 selectively manipulates the second member 16 from the first position to the second position to read and expose the book to the user to allow the user to read the book. Referring again to FIG. 3 the flap 46 preferably has a connector 48 being connected thereto. The connector 48 is preferably a Velcro fastener. Alternatively, the connector 48 may be another connector such as one selected from the group consisting of a mechanical connector, a hook, an adhesive or any combination thereof. The connector 48 facilitates the book being retained in the space 18 when the book cover 10 is lifted off of the ground and conveniently retains the book therein. One skilled in the art should appreciate that the connector 48 should be adequate and strong to maintain the first member 14 being closed relative to the second member 16 even when the book cover 10 is shaken such as during use as a toy item or playing by a child. Preferably, the flap 46 has a portion of the connector 48 or a section of a hook material on the flap. The section of hook material on the flap 46 then mates with a section of loop material on the first member 14. Alternatively, the section of hook material may be disposed on the first member 14 and the section of the loop material may be disposed on the flap 46.

The first member 14 and the second member 16 preferably are formed in the pattern 12. One skilled in the art should appreciate that the pattern 12 may be any other indicia that corresponds to a subject matter and/or topic of the book to make the book cover 10 be aesthetically pleasing and, perhaps, facilitate impulse purchasing of the book and book cover. Also, the book cover 10 can itself be a toy or other play item. One skilled in the art should further appreciate that the book cover 10 has dual functionality.

One such problem in the art is that although book covers of the prior art are directed to children's books there has been a general failure of others to render the children's books used as a play item. The book cover 10 of the present invention is safe to be handled by a child, and in fact pleasing and appealing to a child. This aspect of the present invention is a benefit that contrast greatly with known book covers.

It should be understood that the foregoing description is only illustrative of the present invention. Various alternatives and modifications can be devised by those skilled in the art without departing from the invention. Accordingly, the present invention is intended to embrace all such alternatives, modifications and variances.

What is claimed is:

1. A removable cover for a book comprising:
a first member having a body, said body having a first panel, said first panel forming a first pocket with said body; and
a second member being hingedly connected to said body to pivot between a first position and a second position, said first position being defined as a closed position in which said second member is on said first member, said second position being defined as an opened position in which said first member is pivoted and elevated relative to said second member, said second member having a second panel, said second panel forming a second pocket with said second member, wherein the book is in the first pocket and is in the second pocket, and wherein the cover is positioned on the book.

2. The removable cover of claim 1, wherein said second member is connected to said first member by a line of stitching.

3. The removable cover of claim 1, wherein said first member and said second member are formed in a pattern.

4. The removable cover of claim 1, wherein said first member is removably connected to said second member by a connector.

5. The removable cover of claim 4, wherein said connector is selected from the group consisting of a hook and loop fastener, an adhesive, a mechanical fastener, a hook, a button, and any combinations thereof.

6. The removable cover of claim 1, wherein said first panel and said second panel are each a cloth material, and wherein said first panel is stitched to said first member at a first side, a second side, and a third side, and wherein said second panel is stitched to said second member at a fourth side, a fifth side, and a sixth side.

7. The removable cover of claim 1, wherein said first member and said second member are each deformable members.

8. The removable cover of claim 3, wherein said pattern has indicia of a racecar.

9. The removable cover of claim 1, wherein said second member has a flap, said flap having a portion of said hook and loop fastener thereon for connecting said second member to said first member.

10. The removable cover of claim 9, wherein said flap has a gripping portion.

11. A removable book cover for a book having a first binding portion and a second binding portion, the removable book cover comprising:
a first deformable member having a body with a first panel connected to said first deformable member, said first panel having a first side, a second side, a third side, and a fourth side, said first side, said second side and said third side being connected to said first deformable member, said first deformable member forming a first pocket at said fourth side with said body;
a second deformable member being pivotally connected to said body to pivot from a first position and a second position, said first position being defined as a closed position in which said second deformable member is on said first deformable member, said second position being defined as an opened position in which said first deformable member is pivoted and elevated relative to said second deformable member, said second deformable member having a second panel with a fifth side, a sixth side, a seventh side, and an eighth side, wherein said fifth side, said sixth side, and said seventh side are connected to said second deformable member, said second panel forming a second pocket at said eighth side with said second deformable member, and wherein the first binding portion is selectively in the first pocket of the first deformable member and the second binding portion is selectively in the second pocket of the second deformable member, and wherein the removable cover is positioned on the book; and
a fastener for removably connecting said first deformable member to said second deformable member.

12. The removable book cover of claim 11, wherein said first deformable member is connected to said second deformable member by a line of stitching.

13. The removable book cover of claim 11, wherein said fastener is a hook and loop fastener.

14. The removable book cover of claim 11, wherein said first deformable member and said second deformable member each has an exterior surface with a visually identifiable pattern.

15. The removable book cover of claim 11, further comprising a resilient member being disposed in an interior space of said first deformable member.

16. The removable book cover of claim 11, wherein said first panel is substantially opposite said second panel on said second deformable member in said first position.

17. The removable book cover of claim 13, wherein said fastener is disposed on a lateral side of said second deformable member.

18. The removable book cover of claim 15, wherein said interior space has a soft material in said interior space, said soft material being selected from the group consisting of foam, cloth, cloth stuffing, packing, paper, cotton and any combinations thereof.

19. A book cover for a book with pages having an informational topic, the book cover comprising:
a first stuffed member being connected to a second stuffed member by a pivot, said first stuffed member and said second stuffed member having an exterior surface thereon, said exterior surface having a pattern, wherein said book cover has said pattern being substantially indicative as the information topic of the book, and wherein said book cover is soft relative to a hardness of an exterior surface of the book, and wherein said book cover is an object for which a child may manipulate as a toy and play therewith.

20. The book cover of claim 19, wherein said first stuffed member is connected to said second stuffed member by a line of stitching, and wherein said first stuffed member and said second stuffed member each have an interior space being stuffed with a soft material, said soft material being selected from the group consisting of foam, cloth, cloth stuffing, packing, paper, cotton and any combinations thereof.
